(19) United States
(12) Patent Application Publication
(10) Pub. No.: US 2014/0229345 A1
(43) Pub. Date: Aug. 14, 2014

(54) APPLICATION PROCESS FRAMEWORK FOR INTEGRATED AND EXTENSIBLE ACCOUNTING SYSTEM

(71) Applicant: MICROSOFT CORPORATION, Redmond, WA (US)

(72) Inventors: Arthur Greef, Burien, WA (US); John Healy, Fargo, ND (US); Michael Gall, Kopenhagen (DK); Xavier Chape, Stenlose (DK); Par Akerblom, North Bend, WA (US); Manoj Swaminathan, Issaquah, WA (US)

(73) Assignee: Microsoft Corporation, Redmond, WA (US)

(21) Appl. No.: 13/767,817

(22) Filed: Feb. 14, 2013

(51) Int. Cl. G06Q 40/00

(52) U.S. Cl. CPC G06Q 40/10
USPC 705/30

(57) ABSTRACT

Technologies are generally described for a consistent process, task, and state application architecture pattern from an initial documentation process through the resource accounting, subledger accounting processes, and the general ledger accounting process. Data driven policy and rules may be leveraged for the processing to determine input, results, and state transitioning, where processes may represent operations performed by the accounting system. The application process pattern may be an abstraction of key domain processes and their generic tasks and states. The framework tasks may leverage explicit policy and rule types and/or procedures to determine a result and to validate the state transition.

### BACKGROUND

With the proliferation of computing and networking technologies, conventional business tasks are increasingly automated through hosted business applications. Multi-faceted services addressing a variety of operational needs such as accounting, customer relationship management, inventory management, and similar ones are provided through a hosted service enabling multiple clients to take advantage of centralized solutions while having access for their users through thin or specialized client applications. One of the coveted aspects of business applications or services, accounting, typically allows a wide variety of enterprise operations to be performed and supervised through standardized and regulation-compliant approaches.

Traditional accounting systems typically use subledger transactions as basis to generate general ledger account entries (GLAE). The process for generation of the GLAE is exclusive for each subledger, or even source document, and only subledger transactions sent to the accounting process are evaluated for eligibility for accounting. This traditional application architecture may prevent both consistency in, and reuse of, enterprise-wide processes. There is no shared end-to-end processing, since the enterprise-wide processing starts first after the generation of the basic GLAE. Furthermore, the lack of consistency and integration may make extensions or modifications to the processes complex and costly.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an application architecture pattern for processes, tasks, and states for an integrated and extensible accounting system. Processes may represent operations performed by the accounting system. The application process pattern may be an abstraction of key domain processes and their generic tasks and states. According to some examples, the framework may cover documentation, resource accounting, subledger accounting, and general ledger accounting and core domain processes. In the described multidimensional measurement system for accounting, state transitions for each process may be governed by completions of framework tasks. The processing of these tasks may be controlled by framework procedures. The framework tasks may leverage explicit policy and rule types and/or procedures to determine a result and to validate the state transition. Data driven policy and rules may enable a modeling and configuration experience that can be used to determine a specific value as result for task.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example application process framework for an integrated and extensible accounting system;

FIG. 2 illustrates example processes and associated states, tasks, and results for an application process framework according to some embodiments;

FIG. 3 illustrates an example schema for two example processes in an application process framework according to some embodiments;

FIG. 4 illustrates another example schema for two other example processes in an application process framework according to some embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing an application process framework for an integrated and extensible accounting system, according to embodiments.

### DETAILED DESCRIPTION

As briefly described above, a consistent process, task, and state application architecture pattern may be provided from an initial documentation process through the resource accounting, subledger accounting processes, and the general ledger accounting process. Data driven policy and rules may be leveraged for the processing to determine input, results, and state transitioning. Moreover, subscriptions may be used as a pattern for extensions to the processing.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable hardware. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

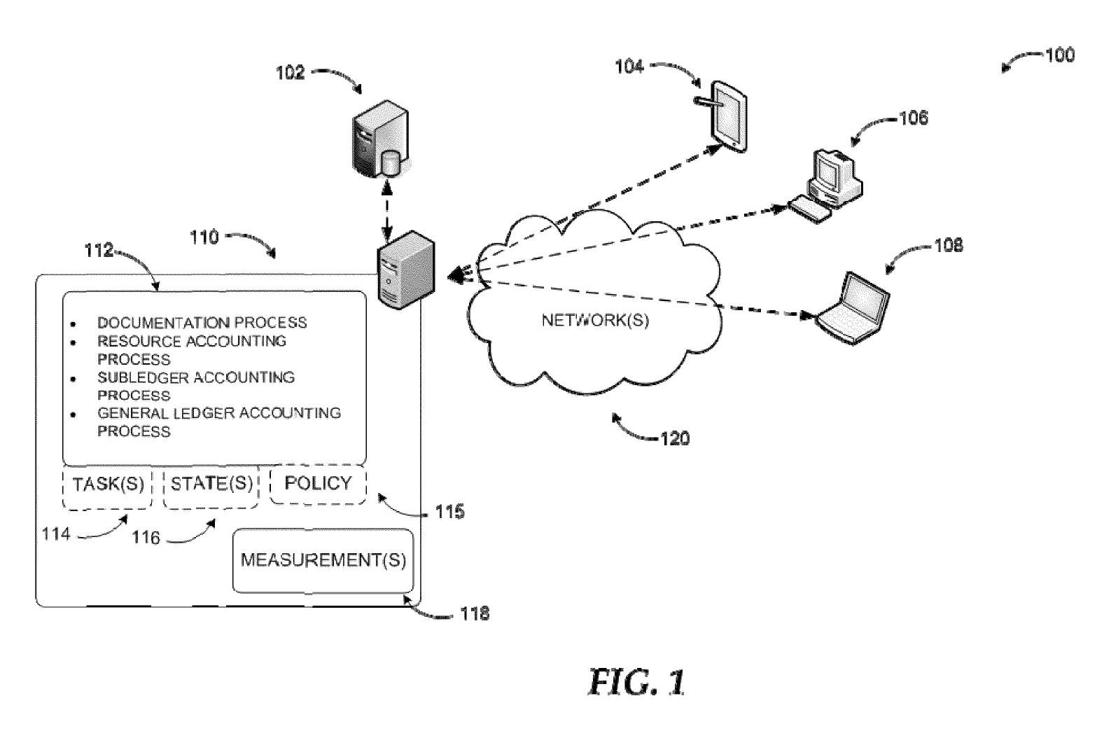

FIG. 1 illustrates an example application process framework for an integrated and extensible accounting system.

As discussed previously, traditional accounting application architectures may prevent consistency in and reuse of enterprise-wide processes making extensions or modifications to the processes complex and costly. Because enterprise-wide processing typically starts first after the generation of the basic GLAE, there is no shared end-to-end processing.

An example system according to sonic embodiments may be implemented as a hosted service executed on one or more servers such as server 110 shown in diagram 100. Storing and retrieving data to and from one or more data stores (e.g., database server 102), the accounting service executed on server 110 may communicate with specialized or generic client applications executed on client devices such as tablet 104, desktop computer 106, laptop computer 108, and similar ones enabling access to its functionality by end users. The exchange of data may occur over one or more wired or wireless networks 120.

The application process architecture may be based on an abstraction of key domain processes 112 and their generic tasks 114, states 116, and an example policy 115. According to sonic examples, the framework may cover documentation, resource accounting, subledger accounting, and general ledger accounting and core domain processes (112). The application transaction process pattern framework described herein may provide support for multidimensional measurements 118 for accounting. State transitions for each process may be governed by completions of framework tasks. The processing of these tasks may be controlled by framework procedures, where each task in the processing framework has a distinct input and result (output). The framework tasks may leverage explicit policy and rule types and/or procedures to determine a result and to validate the state transition. Data driven policy and rules may enable a modeling and configuration experience that can be used to determine a specific value as result for task.

In an example configuration, a documentation policy defined for a specific source document model may secure that required term measurements are documented in order for a specific source document and domain event to perform a state transition from draft to final. The framework may execute the task and also ensure that all domain events and measurements are properly chained, linked, or related together to secure full traceability and auditability end-to-end across source documents and domain processes.

Extensions to the processing framework may be added by subscribing to the framework task events. Thus, the process framework may be kept open for extensions, but closed for modifications. The process framework may be invoked at the core source and may ensure that operational information is captured in a consistent and integrated manner. This may be regardless of whether the domain event being documented has relevance for accounting or not. Source documents, domain events, and measurements follow the same processing pattern and the eligibility for accounting may be validated by rule types and/or procedures. Thus, the process framework may promote a high level of reuse and alignment.

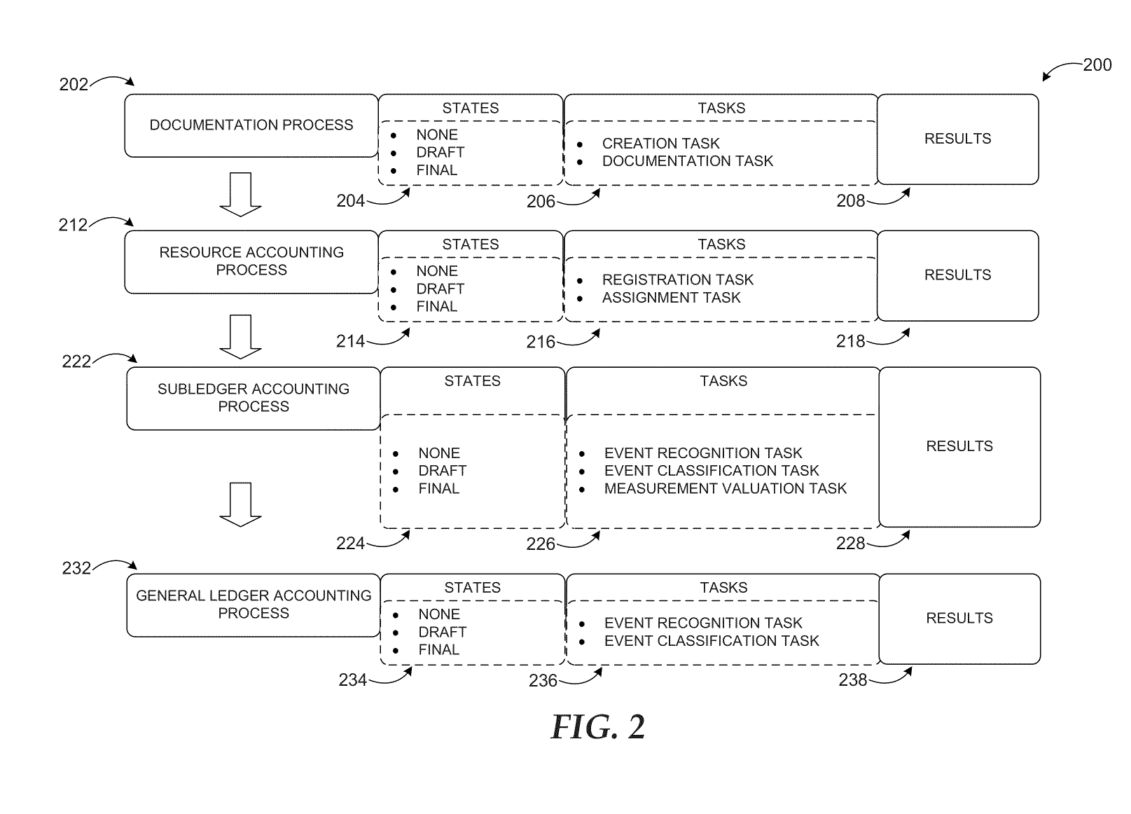

FIG. 2 illustrates example processes and associated slates, tasks, and results for an application process framework according to some embodiments.

Four processes may be used as core processes in an example framework according to embodiments. These may include documentation process 202, resource accounting process 212, subledger accounting process 222, and general ledger accounting process 232. As discussed above, each process may include one or more states, tasks, and results. Diagram 200 shows an example configuration of the four core processes and their associated components.

Documentation process 202 may cover the documentation of an occurrence of an activity in the enterprise domain through the use of a source document. A creation task (206) of the documentation process 202 may generate an abstraction source document with header(s) and lines. The state 204 for the documentation process may transition from None to Draft once the creation task is completed and result(s) 208 provided to the service.

The documentation task may generate the domain events, reference identities, dimension attributes, and base measurement magnitudes by applying policies, rules and procedures to the source document data. Multi-dimensional term, scheduling, allocation and distribution measurements may be generated in a similar way as the domain events. The documentation process 202 may capture the operational consequences of the activity, both external and internal to the enterprise. In some embodiments, it may not be possible to transition to the final state before the documentation requirements are completed for a domain event. The documentation process may submit to resource accounting process at draft finalization.

Resource accounting process 212 may capture the expected (reservation) or realized operational impact of the documented domain event on the resources under the control of the enterprise. The registration task (216) of the resource accounting process 212 may generate registered quantity measurements based on the schedule measurements captured in the documentation process 202. A conversion may occur when the units used for the source document term are different than the units used for a resource register entry (e.g., the purchase quantity term for a product may be in boxes, but the stock register entry for the product may be maintained in pieces). The state 214 for the resource accounting may transition from None to Draft once the register entry events and measurements are created and from Draft to Final once the draft register entry events and measurements are validated and finalized. The resource accounting process may submit the result(s) 218 to subledger accounting process 222 at draft finalization.

Subledger accounting process 222 may capture the expected or realized impact on the resources under the control of the enterprise for one or inure accounting representations by applying the policy rules of one or more accounting conventions when creating account entries in one or more ledgers. Operational events and measurements may be evaluated based on accounting rules, for recognition, classification, and valuation per accounting representation. Multi-dimensional double-sided subledger accounting entries may be generated if an operational measurement is recognized and the classification and valuation rules have determined the magnitude and the dimension units for the account entry measurement. Operational events may be linked to accounting events and operational events may be linked to ledger accounting events for traceability and transparency. The state 224 for the subledger accounting process 222 may transition from None to Draft once the applicable ledger accounting events and measurements are generated.

Double-sided subledger accounting entries may be generated based on the ledger accounting events and measurements, according to some embodiments. Multi-dimensional measurements may be generated based on accounting rules and debit/credit indicators may be added to the associated ledger entries. Ledger accounting measurements may be linked to other ledger accounting measurements for traceability and transparency. The state 226 for the subledger accounting process may transition from Draft to Final once the applicable subledger events, measurements, and account entries are created and validated. The subledger accounting process 222 may submit result(s) 228 to general ledger accounting process 232 at draft finalization.

General ledger accounting process 232 may generate general ledger accounting entries based on recognition and classification rules applied to subledger accounting events and measurements. As for the subledger, there may be one ledger per accounting convention. Subledger accounting measurements may be linked to the general ledger accounting measurements for traceability and transparency. General ledger accounting process 232 may be associated with state 234 (e.g., None, Draft, Final), tasks 236 (e.g., general ledger transfer task), and results 238.

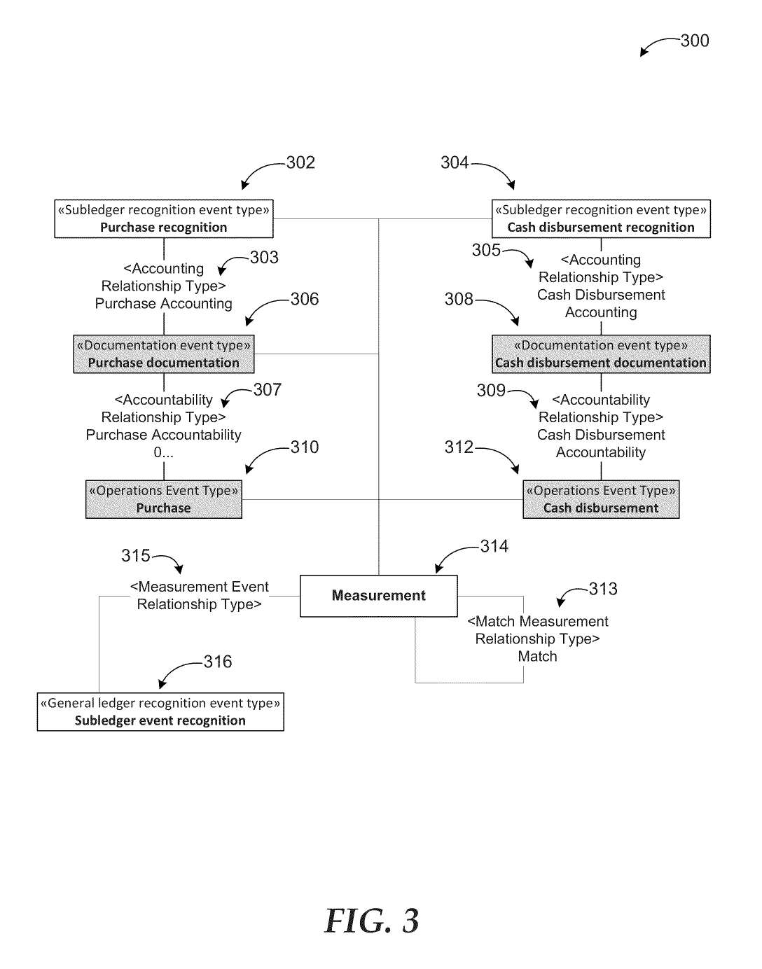

FIG. 3 illustrates an example schema for three example processes in an application process framework according to sonic embodiments.

According to an example scenario, the creating and documentation of a purchase order may initiate the documentation process based on the purchase order source document model. Abstract purchase order header and lines may be generated by a creation task. The source document model is used by the documentation task to create events 306 and 310, to create reference identities (e.g., order date, purchase order type), and to create multidimensional measurements 314 that included both magnitude (e.g., product quantity, unit price, purchase price) and dimension units (e.g., physical unit, product, organization, location). The operational domain event such as “purchase” may be determined based on the purchase document type, for example. The documentation task also creates the relationships between events (e.g., purchase accounting relationship 303, purchase accountability relationship 307, cash disbursement accounting relationship 305, cash disbursement accountability relationship 309) and between events and multidimensional measurements 314 (measurement relationship 315), and between multidimensional measurements themselves (match relationship 313), both base and derived, that characterize these events. The subledger accounting process recognition, classification and evaluation tasks generate events 302 and measurements 314, and the general ledger accounting process transfer task generates event 316 and additional measurements 314.

According to another example scenario, a vendor payment may generate an actual decrement of cash. The cash disbursement documentation event 308, the cash disbursement operations event 312, may capture the relevant units for the multidimensional cash register measurements (i.e., product, location, activity, time, organization, resource and currency unit). As before the subledger accounting process recognition, classification and evaluation tasks generate events 304 and measurements 314, and the general ledger accounting process transfer task generates event 317 and additional measurements 314.

An example flow through a system according to embodiments is provided below. The example scenarios, configurations, order of steps, and results described below are for illustration purposes only and do not constitute a limitation on embodiments. Sample reference identities captured during the creation task of the documentation process for a purchase event:

| Identity reference name | Value |
|---|---|
| Document date | Dec. 15, 2012 |
| Purchase type | Purchase |
| Payment term | EOM |
| Payment due date | Jan. 31, 2013 |
| Vendor account | 4101 |
| Delivery date | Dec. 20, 2012 |
| Item identifier | Product |
| Product configuration | 720 |
| identifier | |
| Site identifier | 1 |
| Warehouse identifier | Main |
| Currency code | USD |

Sample domain events generated by the creation task of the documentation process for a purchase event:

Domain Event (Type/Role/Modifier)

Documentation/Purchase
documentation/Original
Operations/Purchase/Original

Sample measurements generated by the documentation process for a purchase event:

| Measure qualifier | | | | | | | Primal | Dual |
|---|---|---|---|---|---|---|---|---|
| (Role/Type/Modifier) | Magnitude | Time Unit | Qty. unit | Resource | Loc. | Activity | Org. | Org. |
| Term/Product | 10.00 | Dec. 15, 2012 | Box | Product/ | Site1 | Purchase | Contoso | Fabrikam |
| quantity/Consideration | | | | 720 | | | (West)/ | |
| | | | | | | | Purchasing | |
| Term/Product unit | 1,000.00 | Dec. 15, 2012 | USD/ | Product/ | | Purchase | Contoso | Fabrikam |
| price/Consideration | | | Box | 720 | | | (West)/ | |
| | | | | | | | Purchasing | |
| Term/Discount | 0.02 | Jan. 1, 1900 | % | | | Purchase | Contoso | Fabrikam |
| percent/Consideration | | | | | | | (West)/ | |
| | | | | | | | Purchasing | |
| Term/Extended | 10,000.00 | Dec. 15, 2012 | USD | Dollar | | Purchase | Contoso | Fabrikam |
| price/Consideration | | | | | | | (West)/ | |
| (Derived: Product | | | | | | | Purchasing | |
| quantity * Product | | | | | | | | |
| unit price) | | | | | | | | |
| Term/Discount/ | 200.00 | Dec. 15, 2012 | USD | Dollar | | Purchase | Contoso | Fabrikam |
| Consideration | | | | | | | (West)/ | |
| (Derived: Discount | | | | | | | Purchasing | |
| percent * Extended | | | | | | | | |
| price) | | | | | | | | |
| Term/Product price/ | 9,800.00 | Dec. 15, 2012 | USD | Dollar | | Purchase | Contoso | Fabrikam |
| Consideration | | | | | | | (West)/ | |
| (Derived: Extended | | | | | | | Purchasing | |
| price − Discount) | | | | | | | | |
| Schedule/Product | 10.00 | Dec. 20, 2012 | Box | Product/ | Site1/ | | Contoso | Fabrikam |
| quantity/Consideration | | | | 720 | Main | | (West)/ | |
| | | | | | Warehouse | | Purchasing | |
| Schedule/Cash | 9,800.00 | Jan. 31, 2013 | USD | Dollar | | | Contoso | Fabrikam |
| quantity/Obligation | | | | | | | (West)/ | |
| | | | | | | | Purchasing | |

Sample measurements generated by the resource accounting process for a purchase event:

| Measure qualifier | | | | | | Primal | | Dual |
|---|---|---|---|---|---|---|---|---|
| (Role/Type/Modifier) | Magnitude | Time Unit | Qty. unit | Resource | Loc. | Org. | Activity | Org. |
| Registration/Product | 50.00 | Dec. 20, 2012 | Pcs | Product/ | Site1/ | Contoso | Purchase | Fabrikam |
| quantity/Reservation | | | | 720 | Main | (West)/ | | |
| (Derived: based on | | | | | Warehouse | Purchasing | | |
| Schedule/Product | | | | | | | | |
| quantity/Consideration, | | | | | | | | |
| and conversion from | | | | | | | | |
| boxes to pcs for stock | | | | | | | | |
| keeping) | | | | | | | | |
| Registration/Cash | 9,800.00 | Jan. 31, 2013 | USD | Dollar | | Contoso | Purchase | Fabrikam |
| quantity/Reservation | | | | | | (West)/ | | |
| (Derived: based on | | | | | | Purchasing | | |
| Schedule/Cash | | | | | | | | |
| quantity/Obligation) | | | | | | | | |

Sample measurements generated by the ledger accounting process for a product receipt event and a ledger:

| | | | | | | | | | |
|---|---|---|---|---|---|---|---|---|---|
| Measure qualifier | | | | Primal | Dual | | | Dual | Primal |
| (Role/Type/Modifier) | Mag. | Time Unit | Qty. unit | Resource | Resource | Loc. | Activity | Activity | Org. |

| | | | | | | | | |
|---|---|---|---|---|---|---|---|---|
| Recognition/Product | 50 | Dec. 20, 2012 | Pcs | Product/ | | Site1/ | | Contoso |
| cost quantity/ | | | | 720 | | Main | | (West)/ |
| Realization | | | | | | Warehouse | | Logistics |
| Recognition/Product | 10k | Dec. 20, 2012 | USD | Product/ | Material | Site1/Main | | Contoso |
| cost/Realization | | | | 720 | | Warehouse | | (West)/ |
| (Valuation: based | | | | | | | | Logistics |
| on standard cost = | | | | | | | | |
| 200.00 USD/Pcs) | | | | | | | | |
| Expiration/Product | 200 | Dec. 20, 2012 | USD | Product/ | Material | Site1/Main | Purchase | Contoso |
| cost/Realization | | | | 720 | | Warehouse | price | (West)/ |
| (Derived: Product | | | | | | | variance | Logistics |
| cost − Product price) | | | | | | | | |

Sample measurements generated by the subledger accounting process for a product receipt event and a ledger:

| Measure qualifier | | | | Primal | Dual | | Activity | Primal |
|---|---|---|---|---|---|---|---|---|
| (Role/Type/Modifier) | Mag. | Time Unit | Qty. unit | Resource | Resource | Loc. | (Account) | Org. |
| Accounting currency/ | 10k | Dec. 20, 2012 | USD | Dollar | Product/ | Site1/ | Raw | Contoso |
| Product receipt/ | | | | | 720 | Main | material | (West)/ |
| Primary side | | | | | | Warehouse | receipts | Logistics |
| (Reclassification | | | | | | | | |
| of Product cost) | | | | | | | | |
| Accounting currency/ | 200 | Dec. 20, 2012 | USD | Dollar | Product/ | Site1/ | Raw | Contoso |
| Product price | | | | | 720 | Main | material | (West)/ |
| variance/Primary side | | | | | | Warehouse | price | Logislics |
| | | | | | | | variance | |
| Accounting currency/ | −9.8k | Dec. 20, 2012 | USD | Dollar | Product/ | Site1/ | Raw | Contoso |
| Purchase accrual/ | | | | | 720 | Main | material | (West)/ |
| Opposite side | | | | | | Warehouse | purchase | Logistics |
| (Opposite side | | | | | | | accrual | |
| summarized) | | | | | | | | |

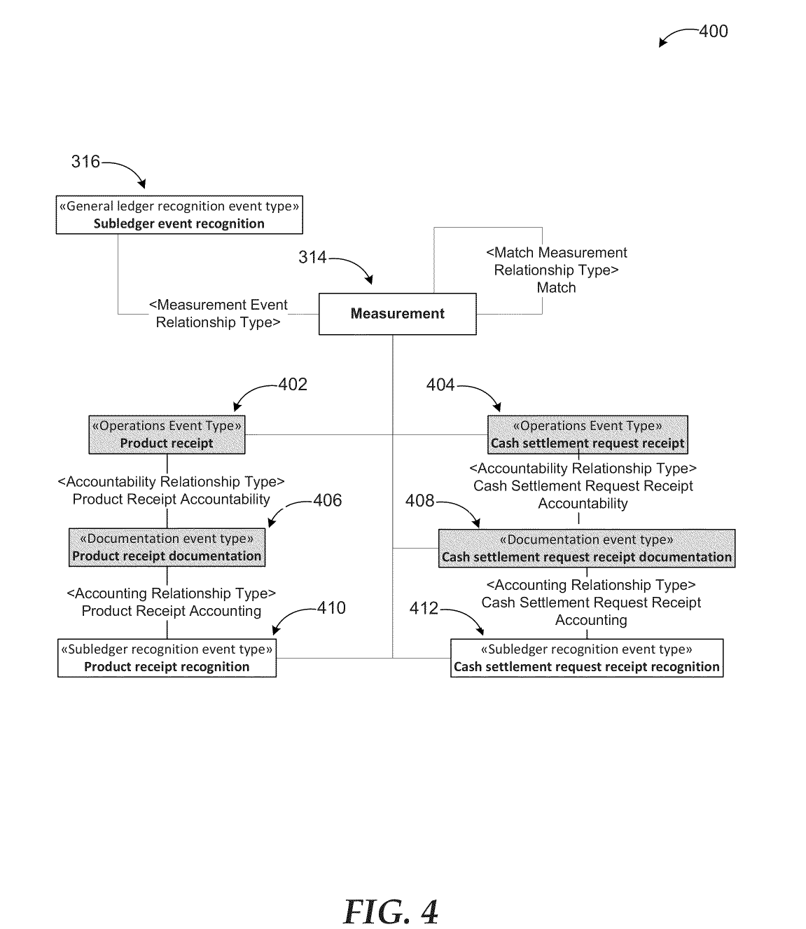

FIG. 4 illustrates another example schema for two other example processes in an application process framework according to some embodiments.

The example operations in diagram 400 include generating the product receipt documentation event 406 deriving an operations event called product receipt 402. The subledger in response to recognition of product receipt as a subledger recognition event (410) and the general ledger in response to recognition of product receipt as a general ledger recognition event 316. The cash settlement request receipt documentation event 408 and the operations event cash settlement request receipt 404 is generated by a vendor invoice documentation task. The subledger recognition event cash settlement request receipt recognition 412 is generated by the tasks in the subledger accounting process. These examples events and others created by the respective tasks may be associated with multidimensional measurements 314 as discussed in FIG. 3.

According to a further example scenario, a monetary cost measurement may be generated for an accounting representation based on the recognition rule for an operational cost product quantity measurement for a product receipt event. The magnitude for the cost measurement may be based on the valuation rule for the accounting representation such as standard cost and the dimensions for cost object and cost element. The chart account unit is derived using classification rules executed by the classification task. Debit product receipt and opposite side credit purchase accrual subledger account entry measurements may be generated based on the ledger accounting cost measurements.

The above discussed configurations are example configurations for illustrative purposes. Embodiments may be implemented with other configurations and approaches using the principles described herein. For example, an application architecture pattern for processes, tasks, and states for an integrated and extensible accounting system may be implemented with additional or fewer core processes, states, tasks, and results than those discussed herein.

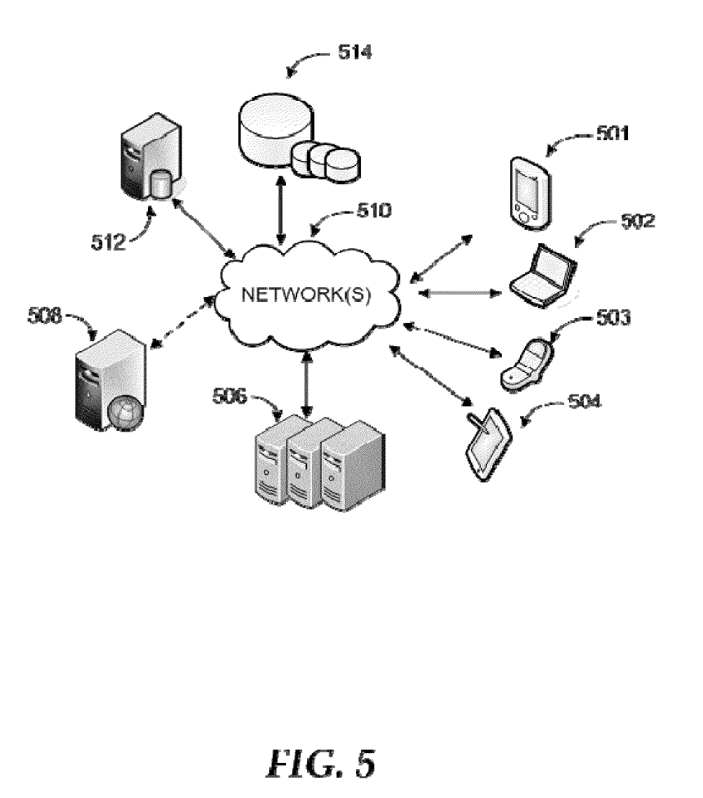

FIG. 5 is an example networked environment, where embodiments may be implemented. In addition to locally installed applications, such as accounting service 622 discussed below, an accounting service may also be employed in conjunction with hosted applications and services that may be implemented via software executed over one or more servers 506 or individual server 508. A hosted accounting service or application may be a web-based service or application, a cloud based service or application, and similar ones, and communicate with client applications on individual computing devices such as a handheld computer 501, a laptop computer 502, a smart phone 503, or a tablet computer 504 (‘client devices’) through network(s) 510 and control a user interface presented to users. Such a service may enable users to interact with accounting service allowing them to feed input, modify operational parameters, receive analysis results, define operational parameters, etc. as discussed herein.

Client devices 501-504 are used to access the functionality provided by the hosted service or application. One or more of the servers 506 or server 508 may be used to provide accounting service as discussed above. Relevant data may be stored in one or more data stores (e.g. data store 514), which may be managed by any one of the servers 506 or by database server 512.

Network(s) 510 may comprise any topology of servers clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a consistent process, task, and state application architecture pattern from an initial documentation process through the resource accounting, subledger accounting processes, and the general ledger accounting process. Furthermore, the networked environments discussed in 5 are for illustration purposes only. Embodiments are not limited to the example applications, modules, or processes.

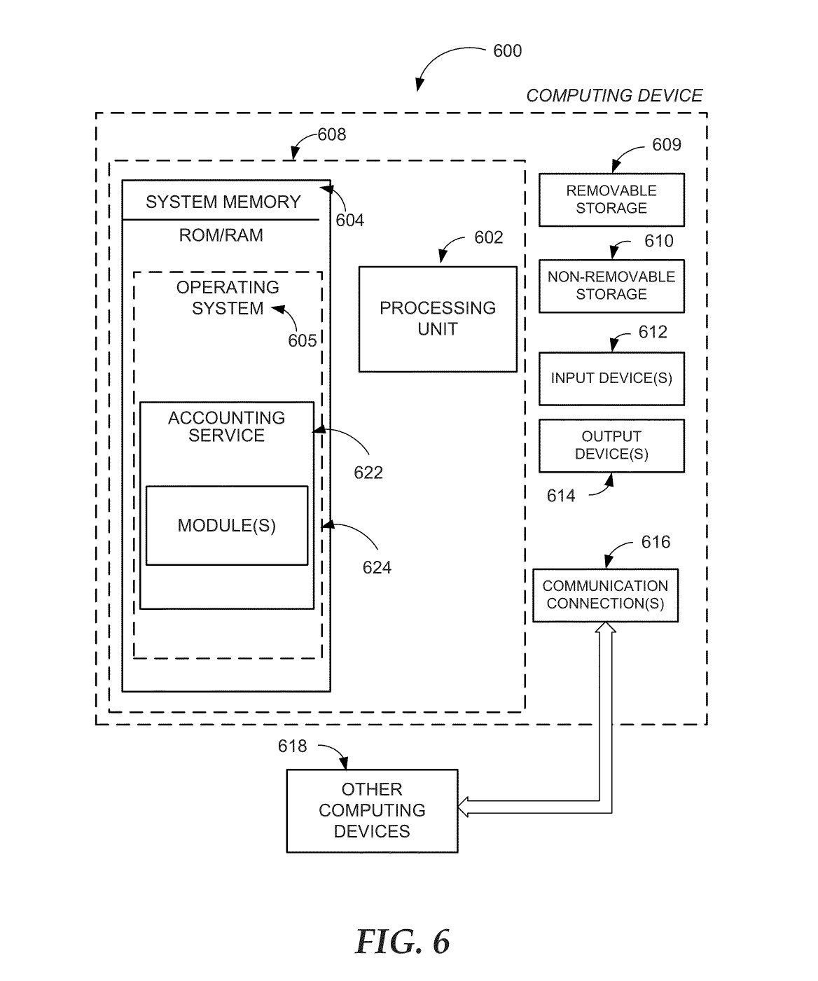

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a server executing an accounting application process framework as described herein, and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS®, WINDOWS MOBILE®, or WINDOWS PHONE® operating systems from MICROSOFT CORPORATION of Redmond, Wash. The system memory 604 may also include one or more software applications such as accounting service 622 and one or more modules 624.

Accounting service 622 may enable performance of various accounting related tasks through a consistent process, task, and state application architecture pattern from an initial documentation process through the resource accounting, subledger accounting processes, and the general ledger accounting process. Data driven policy and rules may be leveraged for the processing to determine input, results, and slate transitioning. Moreover, subscriptions may be used as a pattern for extensions to the processing. Different aspects of the accounting tasks may be performed by the one or more modules 624 according to a configuration of the accounting service 622. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some data entry operation. These human operators need not be collocated with each other, but each can be only with a machine that performs a portion of the program.

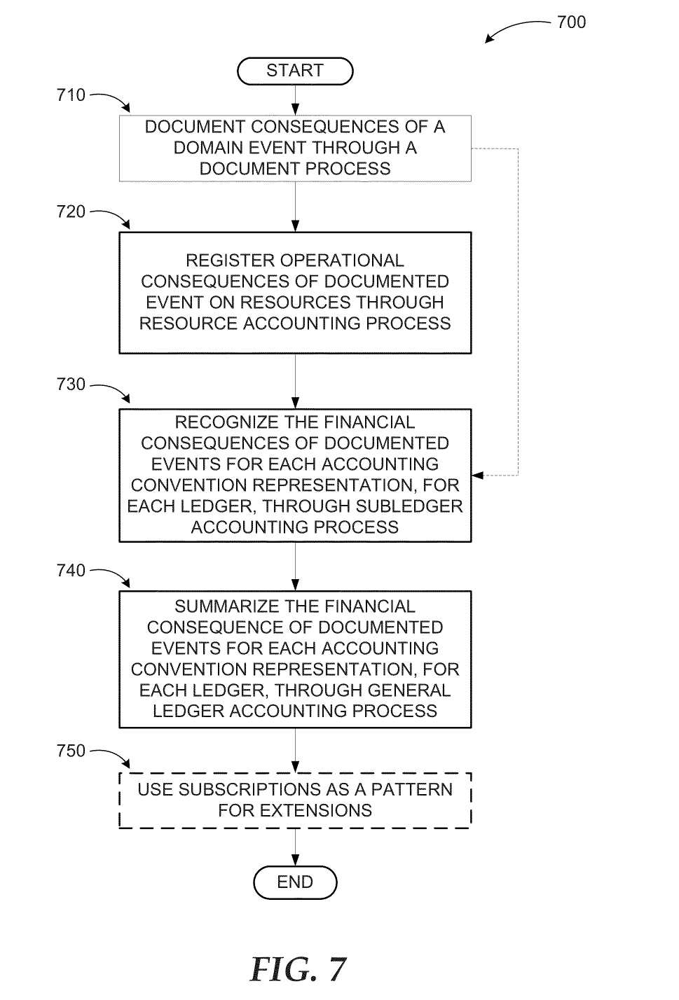

FIG. 7 illustrates a logic flow diagram for a process of providing an application process framework for an integrated and extensible accounting system, according to embodiments. Process 700 may be implemented as part of an accounting service of a locally installed application.

Process 700 begins with operation 710, where the social, operational, and financial consequences of a domain event are documented through a documentation process. A domain event can be a contact formation event (e.g. a purchase order placement), a contract fulfillment event (e.g. a product receipt), or an accounting administration event (e.g. fixed asset deprecation). At operation 720, expected or realized operational consequences of the documented event on economic resources may be registered through a resource accounting process. At operation 730, subledger account entries may be generated that describe the financial consequence of an event for each accounting convention representation, and/or ledgers using a subledger accounting process. In some embodiments, operation 730 may follow operation 710. Resource accounting is not required for fixed asset depreciation accounting events for example. If the event does not increment or decrement a quantity of operational resources, then the resource accounting process may not need to be executed.

At operation 740, general ledger accounting entry measurements may be generated to summarize the financial consequences of one or more events for each accounting convention representation, for each ledger. Operations 710, 720, 730, and 740 may be preceded and followed by optional operation 750, where subscriptions may be used as a pattern for extensions to the framework.

The operations included in process 700 are for illustration purposes. Providing an application process framework for an integrated and extensible accounting system according to embodiments may be implemented by similar processes with fewer or additional steps, as well as in different order of operations using the principles described herein.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method executed at least in part in a computing device for providing an application process framework for an integrated and extensible accounting system, the method comprising:
documenting operational and financial consequences of a domain event through a documentation process of an enterprise at a processing unit of the computing device;
registering the operational consequences external and internal to the enterprise on resources under a control of the enterprise through a resource accounting process at the processing unit of the computing device;
recognizing the financial consequences of the documented event using an accounting convention representation and a ledger through a subledger accounting process at the processing unit of the computing device;
summarizing the financial consequences of the documented event using the accounting convention representation, and the ledger through a general ledger accounting process at the processing unit of the computing device;
managing state transitions for each process based on completions of respective tasks with each process; and
storing at least one of the financial consequences and the ledger in a data store connected to the computing device.

2. (canceled)

3. The method of claim 1, further comprising:
employing one or more predefined events and states within each process to coordinate execution of respective tasks with each process.

4. (canceled)

5. (canceled)

6. The method of claim 1, further comprising:
leveraging explicit policy and one or more of rule types and procedures to determine a result and to validate a state transition within each process.

7. The method of claim 1, further comprising:
determining a specific value as a result for a task employing a modeling and configuration based on data driven policy and rules.

8. The method of claim 1, further comprising:
documenting through the documentation process an occurrence of an activity in an enterprise domain by use of a source document.

9. The method of claim 8, further comprising:
generating an abstract source document with one or more of headers and lines through a creation task of the documentation process;
determining domain events, reference identities, dimension attributes, and measurement magnitudes based on an actual source document through a documentation task of the documentation process based on initial captured information by applying one or more of policies, rules, and procedures, and
submitting results of the documentation process to the resource accounting process upon transitioning an event to a final state in the documentation process.

10. The method of claim 1, further comprising:
generating registered resource quantity measurements based on measurements captured in the documentation process through a registration task of the resource accounting process; and
submitting results of the resource accounting process to the subledger accounting process upon transitioning an event to a final state in resource accounting process.

11. The method of claim 1, further comprising:
recognizing domain events and measurements based on accounting policy rules for recognition, classification, and valuation per accounting representation at the subledger accounting process; and
generating multi-dimensional ledger accounting measurements if an operational measurement is recognized and valuation and classification rules determine a magnitude and dimensions attribute values for the measurement.

12. The method of claim 1, further comprising:
linking domain events for traceability and transparency at each application process.

13. A computing device for providing an application process framework for an integrated and extensible accounting system, the computing device comprising:
a memory storing instructions; and
a processor coupled to the memory, the processor executing an accounting service, wherein the accounting service is configured to:
document operational and financial consequences of a domain event through a documentation process;
register the operational consequences external and internal to the enterprise on resources under a control of the enterprise through a resource accounting process;
recognize the financial consequences of the documented event using an accounting convention representation, and a ledger through a subledger accounting process, wherein the subledger accounting process is configured to capture expected or realized impact on the resources under the control of the enterprise for one or more accounting representations by applying policy rules of one or more accounting conventions when creating account entries in the ledger; and
summarize the financial consequences of the documented event using the accounting convention representation, and the ledger through a general ledger accounting process.

14. The computing device of claim 13, wherein the application process framework is an abstraction of core domain processes and respective generic tasks and states for each process.

15. The computing device of claim 13, wherein each task in the application process framework has a distinct input and a distinct result.

16. The computing device of claim 13, wherein the accounting service is further configured to ensure domain events and measurements are properly chained, linked, and related together to secure full traceability and auditability end-to-end across source documents and domain processes within the accounting system.

17. The computing device of claim 13, wherein source documents, domain events, and measurements are processed following a same processing pattern.

18. The computing device of claim 13, wherein eligibility for accounting recognition is validated by one or more of predefined rule types and procedures.

19. A method for providing an application process framework for an integrated and extensible accounting system, the method comprising:
documenting, operational and financial consequences of a domain event through a documentation process at a processing unit of a server;
validating accounting recognition by one or more predefined rule types and procedures at the processing unit of the server;
recognizing the financial consequences of the documented event using an accounting convention representation, and a ledger through a subledger accounting process at the processing unit of the server;
summarizing the financial consequences of the documented event using the accounting convention representation, and the ledger through a general ledger accounting process at the processing unit of the server;
storing at least one of the financial consequences and the ledger in a data store connected to the computing device; and
linking operational events to accounting events and operational events to ledger accounting events for traceability and transparency at the processing unit of the server.

20. The method of claim 19, further comprising:
leveraging data driven policy and rules for the processes to determine one or more of inputs, results, and state transitioning of each process at the processing unit of the server.
